(19) United States
(12) Patent Application Publication
(10) Pub. No.: US 2011/0042627 A1
(43) Pub. Date: Feb. 24, 2011

(54) THERMISTOR MATERIAL FOR USE IN REDUCING ATMOSPHERE

(76) Inventors: Katsunori Yamada, Aichi (JP); Nobuyuki Ogami, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/937,579

(22) PCT Filed: Apr. 10, 2009
(86) PCT No.: PCT/JP2009/057366

§ 371 Date: Oct. 13, 2010

(30) Foreign Application Priority Data
Apr. 14, 2008 (JP) 2008-104834

(51) Int. Cl. H01B 1/02; H01B 1/00; H01B 1/04

(52) U.S. Cl. 252/516; 252/500; 252/518.1; 252/520.5; 252/521.1

(57) ABSTRACT

Provided is a low-cost, highly responsive, and highly durable thermistor material for use in a reducing atmosphere, with which temperature can be measured even under a reducing atmosphere such as a hydrogen gas atmosphere or in a vacuum without the thermistor material being sealed with a glass seal or a metal tube. The thermistor material includes a matrix material made of an insulating ceramic and a non-oxide conductive material, and conductive particles are dispersed around the matrix material to thereby form a conductive path. The conductive particles are preferably dispersed in a network structure around the matrix material. Further, the conductive particles are preferably dispersed discontinuously around the matrix material.

### TECHNICAL FIELD

The present invention relates to a thermistor material for use in a reducing atmosphere, and more particularly to a thermistor material for use in a reducing atmosphere, the resistance value of which will hardly change with time even when the thermistor is used under a reducing atmosphere such as a hydrogen atmosphere or a carbon dioxide atmosphere or in a vacuum for a long period of time.

### BACKGROUND ART

Thermistors in general refer to resistors whose resistance change relative to a temperature change is large. Thermistors are classified into NTC thermistors whose resistance decreases with increasing temperature, PTC thermistors whose resistance increases with increasing temperature, and CRT thermistors whose resistance rapidly decreases upon exceeding a given temperature. Among such thermistors, NTC thermistors are most often used because their resistance change is proportional to the temperature change. Thus, when the term “thermistor” is used herein, it simply refers to a NTC thermistor.

Commonly used thermistors are made from an oxide complex containing oxides of two to four transition metals such as Mn, Ni, Co, Fe, and Cu. In order for a thermistor to be used as a variety of sensors (e.g., a temperature sensor for use in a high-temperature range), it is necessary that Pt lead wires be joined to a thermistor element with a given shape. Among known methods for joining Pt lead wires are a method including integrally molding Pt lead wires and raw material powders and sintering them, and a method including forming electrodes on the surfaces of a sintered body through a printing process and joining Pt lead wires to the electrode surfaces. A thermistor element with Pt lead wires joined thereto is usually used while being sealed with a glass seal or a metal tube so that a change in the resistance value with time due to factors other than the temperature change is suppressed.

However, when Pt lead wires and raw material powders are integrally molded and sintered, if the sintering temperature of the raw material powders is too high, a problem would arise that the Pt lead wires would degrade during the sintering. Meanwhile, even when a thermistor element is sealed with a glass seal or a metal tube, there is a problem in that the gas components within the sealed space would change, resulting in a change in the resistance value with time.

In order to solve the aforementioned problems, various measures have been proposed so far.

For example, Patent Document 1 discloses a high-temperature thermistor represented by a composition formula: (1−x)SiC+xMO (where 0.05≦x≦0.7 and MO is one or two metal oxides of the groups I to VII and the iron group).

Patent Document 1 describes that adding MO to SiC can provide a high-temperature thermistor that is stable both thermally and chemically.

Patent Document 2 discloses a high-temperature thermistor formed by joining lead wires to the top and bottom surfaces of a sintered body of a Y—Cr—Mn—Ca metal oxide and fuse-sealing them with sealing glass whose average linear expansion coefficient at 30 to 700° C. is 8.5×10⁻⁶/° C. and whose glass-transition temperature is 720° C.

Patent Document 2 describes that the use of sealing glass having an average linear expansion coefficient smaller than those of a metal oxide sintered body and lead wires and having a small difference in linear expansion coefficient from those of the metal oxide sintered body and the lead wires can suppress generation of cracks in the sealing glass.

Patent Document 3 discloses an oxide semiconductor for thermistor, which is represented by the general formula: Mgₓ(Al_{1-y}Cr_{y})₂O₄+a atomic % Ca+b atomic % rare earth element (where 0.95≦x≦1.05, 0≦y≦0.9, 0.1≦a≦5, and 1≦b≦10).

Patent Document 3 describes that when a spinel-type Mg(Al,Cr)₂O₄ solid solution is used while being sealed with a heat-resistance metal cap, if CaO and a rare earth oxide are added to the spinel-type solid solution, oxygen reduction reaction in the spinel-type solid solution is suppressed, whereby a change in the resistance value can be suppressed even when the gas components within the heat-resistant cap have changed.

Patent Document 4 discloses a ceramic composition for thermistor, which is represented by the general formula: (M¹₁₋ₓ.N¹ₓ)M²O₃ (where M¹ is a group 3a element excluding La, N¹ is a group 2a element, M² is a group 4a element to a group 8 element, and 0.002≦x≦0.1).

Patent Document 4 describes that when the dosage x of the divalent element N¹ for M¹M²O₃ is set within a given range, the thermistor will exhibit a stable resistance value even in a reducing atmosphere.

Patent Document 5 discloses a ceramic composition for thermistor, which is represented by the general formula: M¹(P²₁₋ₓ.N²ₓ)O₃ (where M¹ is a group 3a element excluding La, P² is a group 4a element to a group 8a element, an oxide of which exhibits p-type characteristics, N² is a group 4a element to a group 8 element, an oxide of which exhibits n-type characteristics, and 0.1≦x≦0.9).

Patent Document 5 describes that when a p-type semiconductor and an n-type semiconductor whose resistance dependence on the oxygen partial pressure are opposite from each other are mixed with M¹M²O₃, the resistance stability can be maintained even when the oxygen partial pressure has changed, and that degradation of lead wires can be suppressed as the sintering can be conducted at a temperature less than or equal to 1600° C.

Further, Patent Document 6 discloses a ceramic composition for thermistor, which is represented by the general formula: (M¹_{1-X}.N¹_{X})(P²_{1-Y-Z}.N²_{y}.Al_{z})O₃ (where M¹ is a group 3A element excluding La, N′ is a group 2A element, P² is a group 4A element to a group 8 element, an oxide of which exhibits p-type characteristics, N² is a group 4A element to a group 8 element, an oxide of which exhibits n-type characteristics, 0.001≦X/(1−Y−Z)<0.20, 0.05≦Y/(1−Y−Z)≦0.8, and 0<Z/(1−Y−Z)≦0.9).

Patent Document 6 describes that when a p-type semiconductor and an n-type semiconductor whose resistance dependence on the oxygen partial pressure are opposite from each other are mixed with M¹M²O₃, the resistance stability can be maintained even when the oxygen partial pressure has changed, and that degradation of lead wires can be suppressed as the sintering can be conducted at a temperature less than or equal to 1000° C.

### Patent Document 1: JP Patent Publication (Kokai) No. 63-69203

### Patent Document 2: JP Patent No. 3806434

### Patent Document 3: JP Patent Publication (Kokai) No. 5-275206

### Patent Document 4: JP Patent Publication (Kokai) No. 6-338402

### Patent Document 5: JP Patent Publication (Kokai) No. 6-325907

### Patent Document 6: JP Patent Publication (Kokai) No. 7-099103

### DISCLOSURE OF THE INVENTION

### Problems to be Solved by the Invention

A thermistor formed using an oxide ceramic detects temperature utilizing electron conduction due to loss of oxygen. Thus, when such an oxide-based thermistor is used in a reducing atmosphere such as in a hydrogen gas, the amount of oxygen loss would change, whereby the resistance value would also shift (increase) in comparison with the original value. Therefore, in the current circumstances, the sensor element is shielded from gas using a glass seal or a metal tube.

However, using a sealing structure can result in a significant cost increase. In addition, the sealing structure can decrease the response characteristics and durability of the sensor element. Further, there has been conventionally no proposal for a thermistor that is not sealed with a glass seal or a metal tube but is capable of accurate temperature measurement even under a reducing atmosphere.

It is an object of the present invention to provide a thermistor material for use in a reducing atmosphere, with which temperature can be measured even under a reducing atmosphere such as a hydrogen gas atmosphere or a carbon dioxide atmosphere or in a vacuum without the thermistor material being sealed with a glass seal, a metal tube, or the like.

It is another object of the present invention to provide a thermistor material for use in a reducing atmosphere, which is low-cost and is excellent in the response characteristics and durability.

### Means for Solving the Problems

In order to solve the aforementioned problems, a thermistor material for use in a reducing atmosphere in accordance with the present invention includes a matrix material made of an insulating ceramic, and a non-oxide conductive material, wherein conductive particles are dispersed around the matrix material to thereby form a conductive path.

### ADVANTAGES OF THE INVENTION

When conductive particles made of a non-oxide conductive material are dispersed around a matrix material made of an insulating ceramic that is stable in a reducing atmosphere to thereby form a conductive path around the matrix material, it becomes possible to perform stable temperature detection even under a reducing atmosphere. This is because not only is the matrix material difficult to be reduced but also the conductivity of the conductive particles is difficult to be influenced by the reducing atmosphere.

In particular, when a discontinuous conductive path is formed by dispersing the conductive particles at intervals of 1 μm or less (preferably, several 100 nm or less), it becomes possible to perform stable temperature detection even under a reducing atmosphere. This is because forming a discontinuous conductive path can provide a superposition effect of the temperature-dependent semiconductor characteristics and the tunneling conductance characteristics. Further, as the sealing with a glass seal or a metal tube is not necessarily required, the response characteristics and durability can be increased without an increase in the fabrication cost.

The specification includes part or all of the contents as disclosed in the specification and/or drawings of Japanese Patent Application No. 2008-104834 which is a priority document of the present application.

### BEST MODES FOR CARRYING OUT THE INVENTION

Hereinafter, one embodiment of the present invention will be described in detail.

### [1. Thermistor Material for Use in a Reducing Atmosphere]

The thermistor material for use in a reducing atmosphere in accordance with the present invention includes a matrix material and conductive particles.

### [1.1 Matrix Material]

### [1.1.1. Composition]

A matrix material is made of an insulating ceramic. The matrix material can be either an oxide ceramic or a non-oxide ceramic. Alternatively, it can be a mixture of two or more insulating ceramics. The insulating ceramic preferably has an electrical resistivity greater than or equal to 10¹² Ωcm.

Specific examples of oxide ceramics for forming the matrix material include aluminum oxide, mullite, zirconia, magnesia, titanium-aluminum, and zircon. In particular, aluminum oxide is preferable as a matrix material as it has high durability under a reducing atmosphere.

Specific examples of non-oxide ceramics for forming the matrix material include silicon nitride, SiAlON, and aluminum nitride. In particular, silicon nitride is preferable as a matrix material as it has high durability under a reducing atmosphere.

### [1.1.2 Grain Size and Aspect Ratio]

The crystal grain size of the matrix material is not particularly limited, and an optimum size can be selected in accordance with the intended purpose. In general, when the crystal grain size of the matrix material is too small, the intervals between the conductive particles could be short, resulting in a decreased resistance value. Thus, the crystal grain size of the matrix material is preferably greater than or equal to 0.5 μm.

Meanwhile, when the crystal grain size of the matrix material is too large, the strength of the material could decrease. Thus, the crystal grain size of the matrix material is preferably less than or equal to 10 μm.

The aspect ratio of the crystal grain of the matrix material is not particularly limited, and an optimum aspect ratio is selected so that a desired resistance value can be achieved. In general, a high resistance value can be achieved as the aspect ratio is higher because the intervals between the conductive particles can increase correspondingly.

### [1.2 Conductive Particles]

### [1.2.1 Composition]

Conductive particles are made of a non-oxide conductive material with an electrical resistivity lower than that of the matrix material. The electrical resistivity of the conductive particles is preferably 10⁻² to 10⁶ Ωcm.

The conductive particles are dispersed around a crystal grain and/or crystal grains of the matrix material to thereby form a conductive path. In order to form such a conductive path, the conductive particles are preferably a material with a higher sintering temperature than that of the matrix material. In addition, in order to form a conductive path easily, the conductive particles are preferably a material that will not form a compound with the matrix material at the sintering temperature.

Specific examples of non-oxide conductive materials for forming the conductive particles include:

(1) silicon carbide,

(2) silicide, boride, carbide, or nitride of a group 4a element (₂₂Ti, ₄₀Zr, ₇₂Hf, a group 5a element (₂₃V, ₄₁Nb, ₇₃Ta), or a group 6a element (₂₄Cr, ₄₂Mo, ₇₄W) in the periodic table, and

(3) boron.

The conductive particles can contain only one of such materials or a mixture of two or more of them.

Among such materials, silicon carbide is particularly preferable as the conductive particles as it has high durability under a reducing atmosphere.

Alternatively, when the conductive particles contain a mixture of silicon carbide and silicide, boride, carbide, or nitride of a group 4a element to a group 6a element, an advantageous effect can be provided in that the oxidation resistance can be improved than when silicon carbide is used alone.

As a further alternative, when the conductive particles contain silicon carbide or a mixture of silicon carbide and silicide or the like of a group 4a element to a group 5a element, the slope of the temperature vs. resistance (i.e., sensitivity) can be adjusted by further adding boron as the conductive particles.

### [1.2.2 Conductive Path]

A conductive path is formed by dispersing the conductive particles around a crystal grain and/or crystal grains of the matrix material. The crystal grains of the conductive particles and the matrix material can be evenly dispersed with respect to each other. However, the conductive particles are preferably dispersed in a network structure around a single crystal grain of the matrix material or an aggregate (cell) of a plurality of crystal grains of the matrix material.

As used herein, the phrase “dispersed in a network structure” means that the conductive particles are arranged such that they surround the periphery of a single crystal grain or a plurality of crystal grains of the matrix material. When the conductive particles are arranged in a network structure, an advantage can provided in that a conductive path can be formed evenly across the entire material.

The conductive particles are preferably dispersed discontinuously at given intervals therebetween rather than being densely dispersed in close contact with each other. When the conductive particles are in contact with each other, a thermistor that exhibits only the semiconductor characteristics of the conductive particles will result. In that case, the resistance value will saturate at a temperature above a given temperature, and thus the resistance value cannot be changed across a wide temperature range. In contrast, when the conductive particles are dispersed discontinuously, tunneling conductance characteristics are superposed on the semiconductor characteristics. Thus, the resistance value can be changed linearly across a wide temperature range.

The intervals between the conductive particles would influence the resistance value of the material. In general, when the intervals between the conductive particles are too short, the resistance value will be low, resulting in a narrow detectable temperature range. Thus, the intervals between the conductive particles are preferably 0.5 nm on average.

Meanwhile, when the intervals between the conductive particles are too long, the resistance value will be high and detection of current values will be impossible. Thus, the intervals between the conductive particles are preferably less than or equal to 1 μm on average. More preferably, the intervals between the conductive particles are less than or equal to 500 nm on average.

### [1.2.3 Grain Size]

The grain size of the conductive particles would influence the strength and the resistance value. In general, when the grain size of the conductive particles is too large, a relatively large amount of conductive particles need to be added to achieve a given resistance value. However, excessive addition of the conductive particles could result in a decreased strength of the material. Thus, the grain size of the conductive particles is preferably less than or equal to 5 μm. More preferably, the grain size of the conductive particles is less than or equal to 1 μm.

In general, the higher the ratio of the grain size of the conductive particles to the size of a crystal grain and/or crystal grains of the matrix material, the more easily a conductive path can be formed in a network structure. When a method described below is used, a material can be obtained in which the ratio of the grain size (D₂) of the conductive particles to the size (D₁) of a crystal grain or crystal grains of the matrix material (D₂/D₁) is 1/800 to 1/5.

### [1.2.4 Content]

The content of the conductive particles would influence the electrical resistance and the strength of the material. In general, when the content of the conductive particles is too small, the electrical resistance of the material will be too high, and the strength will decrease. In order to achieve moderate electrical resistance and high strength, the content of the conductive particles is preferably greater than or equal to 20 vol %.

Meanwhile, when the content of the conductive particles is excessive, not only will the electrical resistance of the material decrease but also a discontinuous conductive path will be difficult to form. Further, the excessive content of the conductive particles can result in a decreased strength. In order to achieve moderate electrical resistance and high strength, the content of the conductive particles is preferably less than or equal to 40 vol %. More preferably, the content of the conductive particles is less than or equal to 30 vol %.

### [1.3 Sintering Aid]

The material may contain a sintering aid as needed. For the sintering aid, an optimum composition is selected in accordance with the compositions of the matrix material and the conductive particles.

For example, when a composite material of silicon nitride/silicon carbide is used, the sintering aid is preferably Y₂O₃, Al₂O₃, MgAl₂O₄, AlN, MgO, Yb₂O₃, or the like. Such sintering aids can be used either alone or in combination of two or more. In particular, Y₂O₃, Y₂O₃—MgAl₂O₄, or Y₂O₃—Al₂O₃ is preferable. Further, when Y₂O₃—MgAl₂O₄ is used as a sintering aid, the amount of Y₂O₃ is preferably 4 to 10 wt % and the amount of MgAl₂O₄ is preferably 2 to 10 wt %.

### [2. Method for Fabricating a Thermistor Material for Use in a Reducing Atmosphere]

The method for fabricating a thermistor material for use in a reducing atmosphere in accordance with the present invention includes a raw material mixing step, a molding step, and a sintering step.

### [2.1 Raw Material Mixing Step]

A raw material mixing step is the step of obtaining a raw material mixture that contains insulating ceramic powder serving as a matrix material and non-oxide conductive material powder serving as conductive particles.

The raw material mixture can contain only the insulating ceramic powder and the conductive material powder. Alternatively, the raw material mixture can further contain a sintering aid, binder, dispersing agent, and the like as needed. The raw materials are mixed so that a desired composition is achieved.

For the sintering aid, an optimum material is selected in accordance with the compositions of the insulating ceramic and the conductive material. For example, when the insulating ceramic is Si₃N₄ and the conductive material is SiC, the sintering aid can be Y₂O₃, MgAl₂O₃, Yb₂O₃, Al₂O₃, MgO, AlN, or the like.

The binder, dispersing agent, and the like are not particularly limited, and an optimum material can be added in accordance with the intended purpose.

When a material with a relatively low sintering temperature is used as the insulating ceramic and a material with a relatively high sintering temperature is used as the conductive material, only the grains of the matrix material can be grown to a given size without an accompanying grain growth of the conductive particles. According to such a method, the conductive particles can be dispersed in a network structure around a crystal grain and/or crystal grains of the matrix material. The intervals between the particles and the dispersed state can be controlled with the sintering temperature.

However, when powders of different average grain size are used in advance as the starting materials, networking of the conductive particles can be even more facilitated than when the networking is controlled with only the sintering temperature. To that end, the ratio of the average grain size (d₂) of the conductive material powder to the average grain size (d₁) of the insulating ceramic powder (d₂/d₁) is preferably 1/100 to 1/5.

### [2.2 Molding Step]

A molding step is the step of molding the raw material mixture into a given shape.

The molding method is not particularly limited, and an optimum method can be selected in accordance with the intended purpose. Specific examples of the molding method include press molding and CIP molding. Further, in order to reduce the number of the finishing steps after the sintering step, the molded article can be subjected to green machining.

### [2.3 Sintering Step]

A sintering step is the step of sintering the molded article, which has been obtained through the molding step, at a given temperature.

As the sintering temperature, an optimum temperature is selected in accordance with the composition of the material. In general, the higher the sintering temperature, the more easily a high-density sintered article can be obtained. In addition, the higher the sintering temperature, the more easily the grain growth of the matrix material proceeds, whereby the conductive particles become easily dispersed in a network structure. For example, when a Si₃N₄—SiC complex in which the SiC content is 20 to 30 vol % is used, the sintering temperature is preferably 1800 to 1880° C.

For the sintering time, an optimum time is selected in accordance with the sintering temperature.

The thus obtained sintered article is cut into an appropriate size, and electrodes are joined to the opposite surfaces thereof, whereby a thermistor is obtained. The materials of the electrodes are not particularly limited, and various kinds of materials can be used in accordance with the intended purpose.

### [3. Function of the Thermistor Material for Use in a Reducing Atmosphere]

When conductive particles made of a non-oxide conductive material are dispersed around a matrix material made of an insulating ceramic that is stable in a reducing atmosphere to thereby form a conductive path around the matrix material, it becomes possible to perform stable temperature detection even under a reducing atmosphere. This is because not only is the matrix material difficult to be reduced but also the conductivity of the conductive particles is difficult to be influenced by the reducing atmosphere.

In particular, when a discontinuous conductive path is formed by dispersing the conductive particles at intervals of 1 μm or less (preferably, several 100 nm or less), it becomes possible to perform stable temperature detection even under a reducing atmosphere. This is because forming a discontinuous conductive path can provide a superposition effect of the temperature-dependent semiconductor characteristics and the tunneling conductance characteristics. Further, as the sealing with a glass seal or a metal tube is not necessarily required, the response characteristics and durability can be increased without an increase in the fabrication cost.

### EXAMPLES

### Example 1 and Comparative Example 1

### 1. Fabrication of Samples

A Si₃N₄/SiC powder mixture (the SiC content: 30.5 vol %) was fabricated by adding 30 wt % SiC powder (average grain size: 0.4 μm), 6 wt % Y₂O₃ (average grain size: 1 μm) as a sintering aid, and a binder to commercial Si₃N₄ powder (average grain size: 0.5 μm), and subjecting them to wet ball-milling mixing. Then, the powder mixture was molded and subjected to hot pressing in an Ar gas under the conditions of 1850° C.×1 hour. Then, thermistor elements were cut out of the thus obtained Si₃N₄—Y₂O₃—SiC composite material, and electrodes A-H with different histories were joined to the opposite surfaces of the respective elements, whereby thermistor elements were obtained (Example 1). The intervals between the SiC particles was 5 to 10 μm.

For comparison purposes, a commercial oxide thermistor was used in the test (Comparative Example 1).

### 2. Test Method

Each of the obtained thermistors was exposed under a hydrogen atmosphere of 10 hydrogen atmospheric pressures×120° C.×1000 hours or under a vacuum atmosphere of 10⁻⁴ Torr (1.33×10⁻² Pa)×900° C.×1 hour. The resistance value at room temperature was measured before and after the exposure.

### 3. Result

Table 1 shows the change rates of the resistance values of the (six) thermistors obtained in Example 1 at room temperature before and after they were exposed under a hydrogen atmosphere of 120° C.×10 atmospheric pressures for 1000 hours. The resistance change rates of the thermistors obtained in Example 1 before and after the exposure were found to be about less than or equal to 1%.

Meanwhile, when the oxide thermistor (Comparative Example 1) was subjected to an exposure test under the same conditions, the resistance value of the thermistor at room temperature after the exposure was found to be higher than that before the exposure by three digits.

TABLE 1

Resistance
Value (kΩ)

| Sample | | Before | After | Change |
|---|---|---|---|---|
| No. | Electrode | Exposure | Exposure | Rate (%) |
| 1 | A | 77.4 | 75.2 | 1.08 |
| 2 | B | 139.4 | 140.3 | 0.65 |
| 3 | C | 278.6 | 280.4 | 0.65 |
| 4 | D | 254.0 | 255.7 | 0.67 |
| 5 | E | 283.2 | 285.2 | 0.71 |
| 6 | F | 142.4 | 143.5 | 0.77 |

Table 2 shows the change rates of the resistance values of the (two) thermistors obtained in Example 1 at room temperature before and after they were exposed in a vacuum of 900° C.×10⁻⁴ Torr (1.33×0.1⁻² Pa) for 1 hour. The resistance change rates of the thermistors obtained in Example 1 after the exposure test were found to be about ±0.3%.

Meanwhile, when the oxide thermistor (Comparative Example 1) was subjected to an exposure test under the same conditions, the resistance value of the thermistor at room temperature after the exposure was found to be 60 to 70% that before the exposure.

TABLE 2

Resistance
Value (kΩ)

| Sample | | Before | After | Change |
|---|---|---|---|---|
| No. | Electrode | Exposure | Exposure | Rate (%) |
| 7 | G | 38.6 | 38.5 | −0.30 |
| 8 | H | 38.3 | 38.4 | 0.30 |

Although the embodiments of the present invention have been described in detail above, the present invention is not limited to such embodiments, and various modifications are possible without departing from the gist and spirit of the present invention.

### INDUSTRIAL APPLICABILITY

The thermistor material for use in a reducing atmosphere in accordance with the present invention can be used as a temperature sensor for use in a reducing atmosphere.

1. A thermistor material for use in a hydrogen atmosphere, comprising:
a matrix material made of an insulating ceramic; and
conductive particles made of a non-oxide conductive material, the conductive particles being dispersed around the matrix material to form a conductive path.

2. The thermistor material for use in a hydrogen atmosphere according to claim 1, wherein the matrix material contains an oxide ceramic or a non-oxide ceramic.

3. The thermistor material for use in a hydrogen atmosphere according to claim 1, wherein the matrix material contains silicon nitride or aluminum oxide.

4. The thermistor material for use in a hydrogen atmosphere according to claim 1, wherein the conductive particles contain silicon carbide.

5. The thermistor material for use in a hydrogen atmosphere according to claim 1, wherein the conductive particles contain one or more elements selected from the group consisting of silicide, boride, carbide, and nitride of a group 4a element to a group 6a element in the periodic table.

6. (canceled)

7. The thermistor material for use in a hydrogen atmosphere according to claim 1, wherein a ratio of a grain size (D₂) of the conductive particles to a size (D₁) of a crystal grain or crystal grains of the matrix material (D₂/D₁) is 1/800 to 1/5, and the conductive particles are dispersed in a network structure around the crystal grain or the crystal grains of the matrix material.

8. The thermistor material for use in a hydrogen atmosphere according to claim 1, wherein the conductive particles are dispersed discontinuously around the matrix material such that intervals between the conductive particles are 0.5 nm to 1 μm.

9. (canceled)

10. (canceled)

11. The thermistor material for use in a hydrogen atmosphere according to claim 1, further comprising one or more sintering aids selected from the group consisting of Y₂O₃, Al₂O₃, MgAl₂O₄, AlN, MgO, and Yb₂O₃.
